(19) United States
(12) Patent Application Publication
(10) Pub. No.: US 2021/0129688 A1
(43) Pub. Date: May 6, 2021

(54) FREIGHT VEHICLE

(71) Applicants: TOYOTA JIDOSHA KABUSHIKI KAISHA, Toyota-shi (JP); HINO MOTORS, LTD., Hino-shi (JP)

(72) Inventors: Yutaka SAWADA, Nagakute-shi (JP); Yukihide YOKOYAMA, Toyota-shi (JP)

(73) Assignees: TOYOTA JIDOSHA KABUSHIKI KAISHA, Toyota-shi (JP); HINO MOTORS, LTD., Hino-shi (JP)

(21) Appl. No.: 17/071,550

(22) Filed: Oct. 15, 2020

(30) Foreign Application Priority Data
Nov. 5, 2019 (JP) 2019-200659

(51) Int. Cl. B60L 50/71; B62D 33/067

(52) U.S. Cl. CPC B60L 50/71; B60L 2200/36; B62D 33/067

(57) ABSTRACT

A freight vehicle includes a chassis, a body portion having therein a vehicle cabin in which an occupant rides and supported by a front end of the chassis, a tilt mechanism that is provided on the chassis and that tilts the body portion with respect to the chassis, a tank that is disposed on the body portion and stores gas, a gas consuming unit that is supported by the chassis and supplied with the gas to consume the gas, and a pipe that connects the tank and the gas consuming unit and through which the gas flows. At least a part of the pipe is composed of a flexible pipe having a first end fixed to the body portion and a second end fixed to the chassis.

### INCORPORATION BY REFERENCE

The disclosure of Japanese Patent Application No. 2019-200659 filed on Nov. 5, 2019 including the specification, drawings and abstract is incorporated herein by reference in its entirety.

### BACKGROUND

### 1. Technical Field

The present disclosure relates to freight vehicles.

### 2. Description of Related Art

There are vehicles equipped with tanks that store gas consumed for running and for performing various other functions. For example, Japanese Unexamined Patent Application Publication No. 2008-280040 (JP 2008-280040 A) discloses a bus type fuel cell vehicle in which tanks for storing a fuel gas consumed in power generation by a fuel cell are mounted in the ceiling area.

### SUMMARY

In a freight vehicle that is mainly intended to transport freight, when the tanks for storing gas as described above are mounted, the mounting space may be limited because of the necessity of taking a large loading space for freight. For example, if a tank having a cylindrical body as disclosed in JP 2008-280040 A is disposed below the loading space and along side frames that constitute a chassis, the size of the freight vehicle may increase in the front-rear direction depending on the length of the tank. Further, freight vehicles, in general, may be provided with a tilt mechanism for tilting the body portion with respect to the chassis in order to facilitate maintenance inside the body portion. Therefore, in freight vehicles, it is desirable that the tank and the pipe connected to the tank be installed so as not to interfere with the tilting of the body portion. Thus, when the tank is mounted on the freight vehicle, it is necessary to contrive a method of mounting the tank.

The technology of the present disclosure can be implemented as the following aspects.

An aspect of the disclosure provides a freight vehicle. The freight vehicle includes: a chassis; a body portion supported by a front end of the chassis, the body portion having a vehicle cabin in which an occupant rides inside the body portion; a tilt mechanism provided on the chassis and configured to tilt the body portion with respect to the chassis; a tank disposed on the body portion and configured to store gas; a gas consuming unit supported by the chassis and configured to be supplied with the gas to consume the gas; and a pipe configured to connect the tank and the gas consuming unit and configured such that the gas flows through the pipe. At least a part of the pipe is composed of a flexible pipe having a first end fixed to the body portion and a second end fixed to the chassis. With the freight vehicle of the above aspect, by effectively utilizing the space on the body portion, it is possible to mount the tank while suppressing increase in size of the freight vehicle. Further, when the body portion is tilted with respect to the chassis by the tilt mechanism, the flexible pipe is flexibly deformed. Therefore, it is possible to suppress the pipe connecting the tank and the gas consuming unit from hindering a displacement of the tank with respect to the chassis by the tilt mechanism.

In the freight vehicle of the above aspect, the gas consuming unit may include a fuel cell configured to consume the gas to generate electric power. With the freight vehicle of the above aspect, layout of the tank that stores a reaction gas for the fuel cell is facilitated, and therefore, mounting of the fuel cell system is facilitated.

In the freight vehicle of the above aspect, the flexible pipe may have an upstream side portion on a side of the first end and a downstream side portion on a side of the second end, and the flexible pipe may be provided with a docking portion configured to detachably connect the upstream side portion and the downstream side portion. With the freight vehicle of the above aspect, when the tilt mechanism tilts the body portion with respect to the chassis, the flexible pipe can be easily separated into two parts by the docking portion so that the flexible pipe is not subjected to a tension. Thus, it is possible to suppress the pipe connecting the tank and the gas consuming unit from hindering the tilting by the tilt mechanism.

In the freight vehicle of the above aspect, a part of the pipe may be composed of a metal pipe connected to the tank and the flexible pipe and fixed to the body portion, and a pressure regulating valve configured to reduce a pressure of the gas flowing out from the tank may be provided between the metal pipe and the flexible pipe. With the freight vehicle of the above aspect, even when high-pressure gas is stored in the tank, it is possible to suppress the flexible pipe from deteriorating due to the pressure of the gas.

The freight vehicle of the above aspect may further include a container that is provided rearward of the body portion and in which freight is stored, and a storage portion configured to store the tank. A height of the storage portion may be equal to or lower than a height of a top surface of the container. With the freight vehicle of the above aspect, it is possible to suppress increase in dimension of the freight vehicle as a whole in the height direction due to the storage portion for the tank that is disposed on the body portion.

The freight vehicle of the above aspect may further include, when the tank is defined as a first tank, a second tank disposed between the body portion and a loading space that is provided rearward of the body portion and on which freight is loaded and configured to store the gas that is supplied to the gas consuming unit. With the freight vehicle of the above aspect, the number of tanks to be mounted can be increased by effectively utilizing the space between the body portion and the loading space.

The technology according to the present disclosure can also be implemented in various forms other than a freight vehicle. For example, it can be realized in the form of a tank mounting method, a tank mounting structure, and the like for a freight vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a vehicle;

FIG. 2 is a schematic side view of a tractor head;

FIG. 3 is a schematic view showing a pipe connection configuration between tanks and a fuel cell unit; and

FIG. 4 is a schematic side view of the tractor head in which the body portion is tilted.

### DETAILED DESCRIPTION OF EMBODIMENTS

### 1. Embodiment

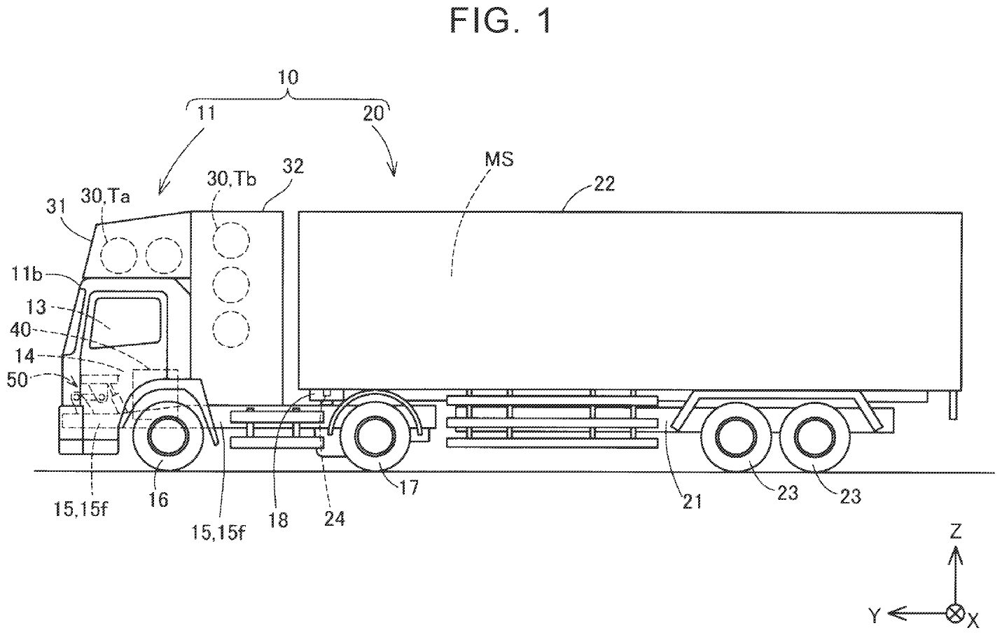

FIG. 1 is a schematic side view showing a vehicle 10 according to the present embodiment. In FIG. 1, arrows indicating an X direction, a Y direction, and a Z direction that are orthogonal to each other are illustrated. The X direction corresponds to a width direction of the vehicle 10, the Y direction corresponds to a front-rear direction of the vehicle 10, and the Z direction corresponds to a height direction of the vehicle 10. The arrows indicating the X direction, the Y direction, and the Z direction in each of the drawings referred to later are illustrated so as to correspond to FIG. 1. It should be noted that the terms “front” and “rear” in the present specification mean “front” and “rear” in the front-rear direction of the vehicle 10.

The vehicle 10 is configured as a freight vehicle. In the present specification, the “freight vehicle” means a vehicle mainly intended to transport freight and having a loading space for freight rearward of a vehicle cabin. The loading space has a larger area than the vehicle cabin when viewed in the height direction. In the specification, the configuration “having a loading space” includes a configuration to which a cargo room and a cargo bed can be added to form the loading space.

In the present embodiment, the vehicle 10 includes a tractor head 11 that is a towing vehicle having a vehicle cabin 13 in which occupants including a driver ride, and a trailer 20 that is a towed vehicle on which freight is loaded. In the vehicle 10, the trailer 20 is connected to the rear of the tractor head 11 to form a freight loading space MS rearward of the vehicle cabin 13. In the present embodiment, the cargo room in a container 22 described later constitutes the freight loading space MS. Thus, the tractor head 11 is configured such that the cargo room and the cargo bed can be added so as to form the loading space MS rearward of the vehicle cabin 13. Thus, according to the definition of the “freight vehicle” in the specification, the tractor head 11 alone to which the trailer 20 is not connected can also be regarded as the freight vehicle.

The tractor head 11 includes a body portion 11b and a chassis 15. The body portion 11b includes therein the vehicle cabin 13 mentioned above and an engine compartment 14 provided below the vehicle cabin 13. The body portion 11b is supported by a front end of the chassis 15. The chassis 15 includes a pair of vehicle frames 15f arranged along the front-rear direction of the vehicle 10. The vehicle frames 15f are also referred to as side frames and are arranged in parallel and spaced from each other in the width direction. The vehicle frames 15f extend rearward of the body portion 11b from the engine compartment 14 in the body portion 11b along the Y direction.

Front wheels 16 and rear wheels 17 of the tractor head 11 are attached to the outer sides of the chassis 15 in the X direction. The front wheels 16 are located below the vehicle cabin 13, and the rear wheels 17 are located near the rear end of the chassis 15. The front wheels 16 are drive wheels that are connected to a driving force source (not shown) housed in the engine compartment 14 and are rotated by the driving force transmitted from the driving force source. In the present embodiment, the driving force source is composed of a motor (not shown). The rear wheels 17 are provided at the rear end of the chassis 15.

In the vicinity of the rear wheels 17, a connected portion 18 is provided in a central portion interposed between the vehicle frames 15f. The connected portion 18 is fixed to the chassis 15. A connecting portion 24 of the trailer 20 is connected to the connected portion 18. The connected portion 18 is composed of a so-called coupler.

The trailer 20 has a trailer chassis 21 and a container 22 supported by the trailer chassis 21. The trailer chassis 21 is composed of trailer frames arranged along the front-rear direction of the vehicle 10. Driven wheels 23 are attached to portions of the trailer chassis 21 near the rear end of the trailer chassis 21. Further, the connecting portion 24 that is connected to the connected portion 18 of the tractor head 11 described above is provided at a portion of the trailer chassis 21 near the front end of the trailer chassis 21. The connecting portion 24 is composed of a so-called kingpin. The connecting portion 24 projects downward and is inserted into and engaged with the connected portion 18 from above. The trailer 20 is connected to the tractor head 11 while being allowed to turn in the width direction with respect to the tractor head 11.

The container 22 constitutes the loading space MS of the vehicle 10 and includes therein a cargo room in which freight is stored. In the present embodiment, the height of the top surface of the container 22 is higher than that of the top surface of the body portion 11b of the tractor head 11. In other embodiments, the container 22 may be omitted. In the trailer 20, instead of the container 22, a fixture for fixing the freight may be provided on the trailer chassis 21.

The vehicle 10 includes a plurality of tanks 30 that stores gas consumed by the vehicle 10. Each tank 30 has a cylindrical body and is disposed along the width direction of the vehicle 10. In the present embodiment, each tank 30 has the same dimensions. However, in other embodiments, the dimensions of each tank 30 need not be uniform. The tanks 30 may differ in diameter or length.

In the present embodiment, the vehicle 10 is configured as a fuel cell vehicle, and the tanks 30 store a fuel gas consumed in power generation by the fuel cell described later. In the present embodiment, the tanks 30 store hydrogen as the fuel gas. Each tank 30 is configured as a high-pressure tank having a pressure resistance of, for example, 70 MPa or more, and can store a fuel gas compressed to high pressure. Each tank 30 has a structure in which the surface of a liner, which is a resin container, is covered with a fiber-reinforced resin layer serving as a reinforcing layer. The liner may be made of a light metal such as aluminum instead of the resin member. The fiber-reinforced resin layer is formed by a filament winding method. The fiber-reinforced resin layer is composed of reinforcing fibers such as carbon-fiber-reinforced plastic (CFRP) wound around the outer surface of the liner, and a thermosetting resin that binds the reinforcing fibers together.

In the present embodiment, the vehicle 10 is provided with a first storage portion 31 and a second storage portion 32 as storage portions for the tanks 30. Each of the storage portions 31, 32 is composed of a hollow box body. Each of the storage portions 31, 32 is made of, for example, acrylonitrile butadiene styrene (ABS) resin or fiber-reinforced plastic. The first storage portion 31 is provided on the body portion 11b of the tractor head 11. In the first storage portion 31, the tanks 30 are arranged side by side in the front-rear direction. The second storage portion 32 is provided between the body portion 11b and the container 22, that is, between the vehicle cabin 13 and the loading space MS. The second storage portion 32 is fixed on the chassis 15. In the second storage portion 32, the tanks 30 are arranged side by side in the height direction. Hereinafter, each of the tanks 30 stored in the first storage portion 31 is also referred to as “first tank Ta”, and each of the tanks 30 stored in the second storage portion 32 is also referred to as “second tank Tb”. The configuration inside each storage portion 31, 32 will be described later.

The vehicle 10 includes, as an electric power source, a fuel cell unit 40 including a fuel cell. The fuel cell unit 40 is a unit including a fuel cell and devices integrally attached to a fuel cell body. The “devices integrally attached to the fuel cell body” include, for example, a case for accommodating the fuel cell, a frame for supporting the fuel cell, sensors, valves, pumps, pipe connecting members, and the like. The fuel cell unit 40 is mounted in the engine compartment 14. The fuel cell unit 40 is supported by the chassis 15 via a mount. In the vehicle 10 of the present embodiment, the electric power output from the fuel cell unit 40 is mainly used for traveling of the vehicle 10.

In the present embodiment, the fuel cell included in the fuel cell unit 40 is a polymer electrolyte fuel cell, and is configured as a fuel cell stack in which a plurality of unit cells is stacked. Each unit cell has a membrane electrode assembly in which electrodes are arranged on the opposite sides of an electrolyte membrane, and is an element that can generate electric power by itself. The fuel cell mounted in the vehicle 10 is not limited to the polymer electrolyte fuel cell. In other embodiments, various types of fuel cells, such as a solid oxide fuel cell, can be used as the fuel cell.

A fuel cell generates electric power by an electrochemical reaction between a fuel gas and an oxidant gas. As described above, in the present embodiment, hydrogen stored in each tank 30 is used as the fuel gas. Further, as the oxidant gas, oxygen contained in air taken in by a compressor (not shown) installed in an area below the vehicle cabin 13 is used. In the vehicle 10 of the present embodiment, the fuel cell of the fuel cell unit 40 functions as a gas consuming unit that is supplied with and consumes the gas stored in the tanks 30. The pipe connection configuration between the tanks 30 and the fuel cell unit 40 will be described later.

The vehicle 10 further includes a tilt mechanism 50 that tilts the body portion 11b of the tractor head 11 with respect to the chassis 15. The tilt mechanism 50 is installed in the engine compartment 14. The tilt mechanism 50 is provided at the front end of the chassis 15. Details of the tilt mechanism 50 will be described later.

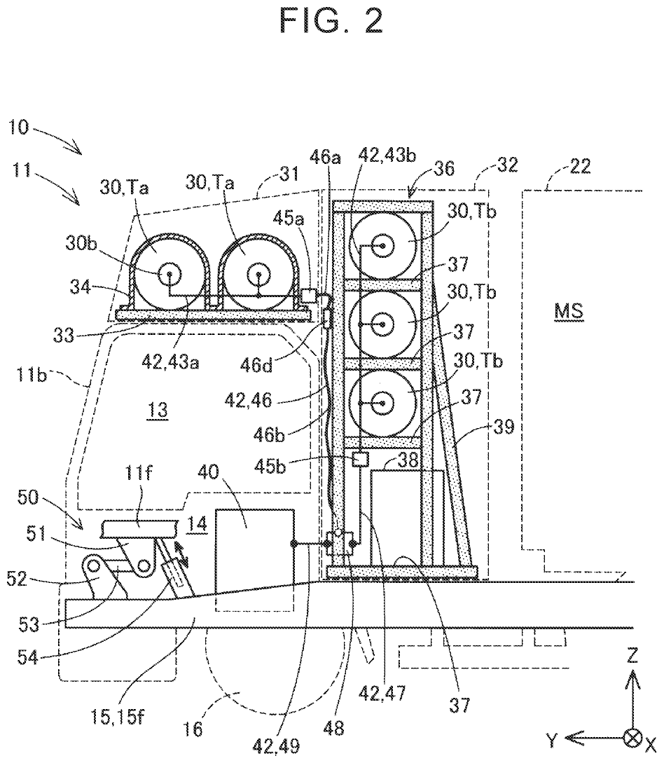

FIG. 2 is a schematic side view showing the internal configuration of the tractor head 11 and the storage portions 31, 32 provided in the tractor head 11. The first storage portion 31 has an installation portion 33 on which the first tanks Ta are installed, and a fixture 34 that fixes the first tanks Ta to the installation portion 33. The installation portion 33 is composed of a frame member fixed to the top surface of the body portion 11b. The fixture 34 is composed of, for example, a metal belt-shaped member having both ends fixed to the installation portion 33 and is wound around the first tanks Ta to fasten the first tanks Ta to the installation portion 33.

The second storage portion 32 includes therein a storage shelf 36 that supports the second tanks Tb. The storage shelf 36 is configured by connecting a plurality of metal frame members. The storage shelf 36 has a plurality of installation portions 37 arranged side by side in the height direction of the vehicle 10. The second tanks Tb are installed one by one on each of the installation portions 37 and fixed by fixtures (not shown).

In the present embodiment, system auxiliary equipment 38 including various devices constituting the fuel cell system is installed on the lowermost installation portion 37 of the storage shelf 36. The system auxiliary equipment 38 includes, for example, an electronic control unit (ECU) that controls the operation of the fuel cell system and a secondary battery. Note that in other embodiments, the installation space for the system auxiliary equipment 38 need not be provided in the second storage portion 32.

The storage shelf 36 is provided with a support member 39. The support member 39 is composed of a columnar member, and is disposed so as to extend obliquely from a portion on the upper end side of the storage shelf 36 to a portion of the lowermost installation portion 37, which is extended rearward. The support member 39 enhances the stability of the installation posture of the storage shelf 36 in the front-rear direction.

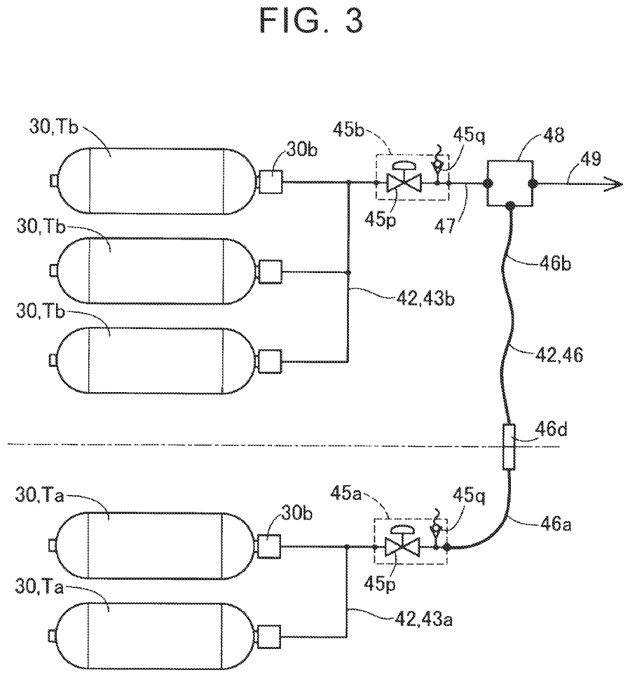

With reference to FIG. 3, the pipe connection configuration between the tanks 30 and the fuel cell unit 40 in the vehicle 10 will be described. The vehicle 10 includes a plurality of pipes 42 that connects each tank 30 and the fuel cell unit 40 and through which the gas stored in the tanks 30 flows, regulators 45a, 45b that adjust the pressure of the gas flowing through the pipes 42, and a merging portion 48 that merges the pipes 42.

Part of the pipes 42 includes a first branch pipe 43a and a second branch pipe 43b. The first branch pipe 43a has an upstream side part branched and connected to each of the first tanks Ta. The second branch pipe 43b has an upstream side part branched and connected to each of the second tanks Tb. The branch pipes 43a, 43b are connected to caps 30b of the tanks 30. Although not shown, each of the caps 30b has a check valve for suppressing leakage of gas to the outside of the tank 30 and a fusion valve that melts when its temperature exceeds a certain temperature to allow the gas to leak to the outside of the tank 30. Each of the branch pipes 43a, 43b is composed of a metal pipe and has such a pressure resistance as to withstand the pressure of the high-pressure gas flowing out from each tank 30.

A downstream end of the first branch pipe 43a is connected to a first regulator 45a, and a downstream end of the second branch pipe 43b is connected to a second regulator 45b. Each regulator 45a, 45b has a pressure regulating valve 45p and a relief valve 45q. The pressure regulating valve 45p reduces the pressure of the gas flowing in from the tanks 30 to a predetermined upper limit pressure. The relief valve 45q is provided on the downstream side of the pressure regulating valve 45p, and when the gas having a pressure higher than the upper limit pressure flows in, the relief valve 45q opens to release the pressure by which the upper limit pressure is exceeded to the outside.

The pipes 42 further include a flexible pipe 46 connecting the first regulator 45a and the merging portion 48, a fixed pipe 47 connecting the second regulator 45b and the merging portion 48, and a merging pipe 49 connecting the merging portion 48 and the fuel cell unit 40. The flexible pipe 46 is composed of, for example, a resin pipe and has flexibility. The flexible pipe 46 is detachably connected to the first regulator 45a and the merging portion 48. Since the gas having a pressure reduced by the first regulator 45a flows into the flexible pipe 46, the pressure resistance of the flexible pipe 46 may be lower than that of the first branch pipe 43a. In the present embodiment, the flexible pipe 46 has an upstream side portion 46a and a downstream side portion 46b, and is provided with a docking portion 46d that detachably connects the upstream side portion 46a and the downstream side portion 46b. Although illustration is omitted, the docking portion 46d is composed of a tubular metal male portion and a tubular metal female portion into which the male portion is airtightly inserted, and connects the upstream side portion 46a and the downstream side portion 46b with the engagement of the male portion and the female portion.

The fixed pipe 47 and the merging pipe 49 are each made of a metal pipe similar to the second branch pipe 43b. The merging pipe 49 is provided with an injector (not shown) that injects the fuel gas into the flow path of the fuel cell unit 40. In addition, a circulation pipe (not shown) for circulating to the fuel cell unit 40 the fuel gas discharged without being used for power generation in the fuel cell unit 40 is connected to the merging pipe 49.

With reference to FIG. 2, the first branch pipe 43a and the first regulator 45a described above are installed in the first storage portion 31 together with the first tanks Ta, and are fixed to the body portion 11b. The second branch pipe 43b, the second regulator 45b, and the fixed pipe 47 are installed in the second storage portion 32 together with the second tanks Tb.

The merging portion 48 and the merging pipe 49 are not fixed to the body portion 11b, but are fixed to the chassis 15. In the present embodiment, the merging portion 48 is installed in the second storage portion 32. Note that, in FIG. 2, for convenience, the merging portion 48 is illustrated as being fixed to the storage shelf 36, but the merging portion 48 may be fixed to the inner wall surface of the second storage portion 32, or may be directly fixed to the chassis 15. Further, in other embodiments, the merging portion 48 need not be installed in the second storage portion 32, and may be installed in the body portion 11b and fixed to the chassis 15.

The flexible pipe 46 is routed from the first regulator 45a fixed to the body portion 11b to the merging portion 48 fixed to the chassis 15. That is, one end (first end) of the flexible pipe 46 is fixed to the body portion 11b via the regulator 45a so as to be displaceable together with the body portion 11b at the time of the tilting described later. The other end (second end) of the flexible pipe 46 is fixed to the chassis 15 via the merging portion 48. In the present embodiment, it is construed that the upstream side portion 46a of the flexible pipe 46 constitutes the pipe on the body portion 11b side, and the downstream side portion 46b constitutes the pipe on the chassis 15 side, with the connecting portion at the docking portion 46d serving as a boundary.

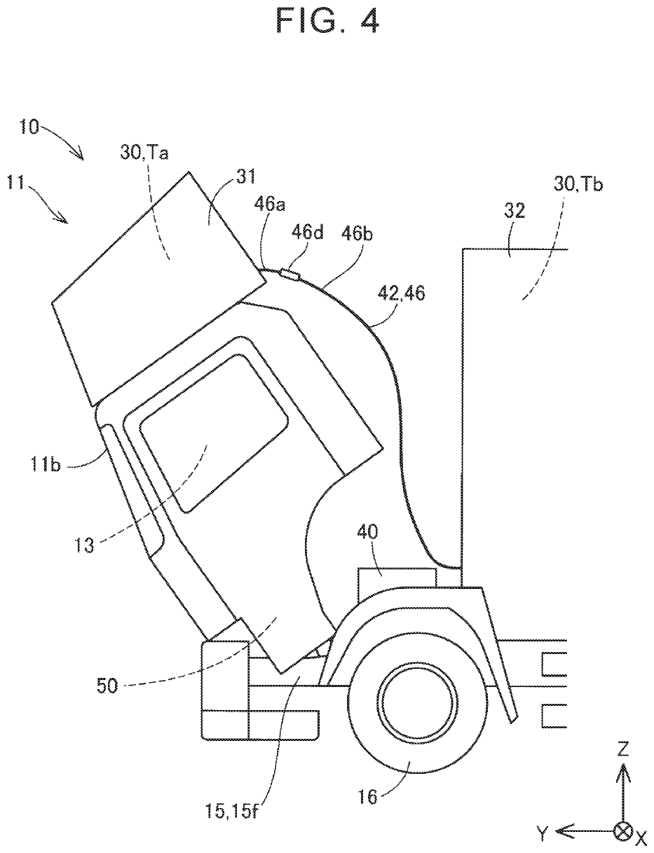

The tilt mechanism 50 and the tilting of the tractor head 11 by the tilt mechanism 50 will be described with reference to FIGS. 2 and 4. FIG. 4 is a schematic side view of the tractor head 11 in which the body portion 11b is tilted by the tilt mechanism 50.

With reference to FIG. 2, the tilt mechanism 50 includes a first bracket 52 fixed to the chassis 15, a second bracket 51 fixed to a body frame 11f of the body portion 11b, a link 53 connecting the two brackets 51, 52, and a telescopic arm 54. The telescopic arm 54 is composed of a hydraulic cylinder or an air cylinder. The telescopic arm 54 has a rear end fixed to the chassis 15 and a front end fixed to the body frame 11f.

When the telescopic arm 54 extends, the body frame 11f is pushed up, and the body portion 11b pivots so as to tilt forward with respect to the chassis 15, as shown in FIG. 4. This pivot movement of the body portion 11b is referred to as tilting. With this tilting, the engine compartment 14 is opened, and the fuel cell unit 40 covered by the body portion 11b and peripheral devices are exposed to the outside, so that maintenance thereof can be performed.

Here, the first tanks Ta in the first storage portion 31 are displaced with respect to the chassis 15 together with the body portion 11b when the body portion 11b is tilted. In the vehicle 10 of the present embodiment, as described above, part of the pipes 42 connecting the first tanks Ta and the fuel cell unit 40 is composed of the flexible pipe 46. When the body portion 11b is tilted, the flexible pipe 46 is flexibly deformed to allow the displacement of the first tanks Ta with respect to the chassis 15.

Further, with the vehicle 10 of the present embodiment, the flexible pipe 46 can be separated into the upstream side portion 46a and the downstream side portion 46b by the docking portion 46d. Therefore, when the flexible pipe 46 is subjected to a tension due to the tilting of the body portion 11b, the connection by the docking portion 46d is released so that it is possible to suppress the flexible pipe 46 from hindering the tilting of the body portion 11b. Note that when the upstream side portion 46a and the downstream side portion 46b are separated, the check valve provided in the cap 30b of each first tank Ta is closed, so that the outflow of gas from the first tanks Ta can be suppressed.

With the vehicle 10 of the present embodiment, the first regulator 45a is provided on the upstream side of the flexible pipe 46, and the pressure of the gas flowing from the first tanks Ta into the flexible pipe 46 is reduced by the pressure regulating valve 45p and the relief valve 45q of the first regulator 45a. Thus, deterioration of the flexible pipe 46 due to the inflow of high-pressure gas from the first tanks Ta is suppressed.

In the vehicle 10 of the present embodiment, as described above, the layout of the tanks 30 storing the reaction gas for the fuel cell on the body portion 11b is facilitated by using the flexible pipe 46. Thus, the fuel cell system can be easily installed in the limited space of the freight vehicle. Further, in the vehicle 10 of the present embodiment, the height of the first storage portion 31 that stores the first tanks Ta is equal to or lower than that of the top surface of the container 22. Therefore, increase in dimension of the vehicle 10 as a whole in the height direction due to the first storage portion 31 is suppressed.

In the vehicle 10 of the present embodiment, besides the first tanks Ta mounted on the body portion 11b, the second tanks Tb are mounted between the body portion 11b and the loading space MS. Thus, the number of tanks 30 mounted is increased while suppressing increase in size of the vehicle 10 in the width direction and the front-rear direction. Accordingly, the amount of gas stored in the vehicle 10 is increased, thereby increasing the cruising range of the vehicle 10.

### 2. Other Embodiments

The various configurations described in the above embodiment can be modified as follows, for example. Each of the other embodiments described below is regarded as an example of modes for carrying out the technology of the present disclosure, like the above-described embodiment.

### Other Embodiment 1

The vehicle 10 need not be configured as a fuel cell vehicle. The vehicle 10 may be configured as a natural gas vehicle, for example. In this case, the natural gas is stored in the tanks 30, and the vehicle 10 is equipped with, as a gas consuming unit, an engine that is driven by combustion of the natural gas stored in the tanks 30. Further, the vehicle 10 may be configured as a hydrogen vehicle in which hydrogen is stored in the tanks 30 and a hydrogen engine is mounted as the gas consuming unit. In such configurations, the vehicle 10 need not include the fuel cell unit 40.

### Other Embodiment 2

In the vehicle 10 of the above embodiment, the electric power generated by the fuel cell unit 40 consuming the fuel gas in the tanks 30 need not be used for traveling of the vehicle 10. The electric power output by the fuel cell unit 40 may be consumed only by the electrical components of the vehicle 10 or may be used only for external power supply. In the vehicle 10 of the above embodiment, some or all of the tanks 30 may store oxidant gas instead of the fuel gas.

### Other Embodiment 3

In the above embodiment, part of the pipes 42 connecting the tanks 30 and the fuel cell unit 40 is composed of the flexible pipe 46. However, the pipes 42 as a whole may be composed of the flexible pipe 46. In this case, it is desirable that the tanks 30 store gas at a pressure that matches the pressure resistance of the flexible pipe 46. In the above embodiment, the flexible pipe 46 may have one end on the upstream side directly fixed to the body portion 11b, or the other end on the downstream side directly fixed to the chassis 15. The docking portion 46d of the flexible pipe 46 may be omitted. In the above embodiment, the flexible pipe 46 may be directly connected to the cap 30b of each tank 30.

### Other Embodiment 4

In the vehicle 10 of the above embodiment, the first storage portion 31 and the second storage portion 32 may be omitted. The first tanks Ta and the second tanks Tb may be mounted on the vehicle 10 in a state where part of or all of the first tanks Ta and the second tanks Tb are exposed to the outside.

### Other Embodiment 5

In the vehicle 10 of the above embodiment, the numbers of the first tanks Ta and the second tanks Tb are not particularly limited. Only one first tank Ta may be mounted, or any number that is two or more of the first tanks Ta may be mounted. Moreover, no second tank Tb may be mounted, and any number that is one or more of the second tanks Tb may be mounted. In the vehicle 10, the tanks 30 may be mounted in an area other than the area between the body portion 11b and the loading space MS, besides on the body portion 11b. For example, the tanks 30 may be mounted between the vehicle frames 15f.

### Other Embodiment 6

The installation postures of the tanks 30 in the storage portions 31, 32 are not limited to such a posture that the longitudinal direction thereof coincides with the width direction of the vehicle. For example, in the first storage portion 31, the tanks 30 may be arranged so that their longitudinal direction coincides with the front-rear direction of the vehicle. Further, in the second storage portion 32, the tanks 30 may be arranged so that their longitudinal direction coincides with the height direction of the vehicle.

### Other Embodiment 7

In the above embodiment, the vehicle 10 is not limited to a freight vehicle in which the trailer 20 is towed by the tractor head 11. The vehicle 10 may be configured, for example, as a truck in which a cargo bed or a cargo room constituting the loading space MS is always fixed to the rear of the vehicle cabin 13.

### 3. Others

The technology of the present disclosure is not limited to the above-described embodiments, and can be implemented with various configurations without departing from the scope of the disclosure. For example, the technical features in the embodiments, examples, and modifications corresponding to the technical features in the aspects described in the SUMMARY may be appropriately replaced or combined in order to solve part of or all of the above-mentioned issues or in order to achieve part of or all of the above-mentioned effects. Further, not only the technical features that are described as non-essential in the specification but also other technical features may be appropriately omitted unless described as essential in the specification.

What is claimed is:

1. A freight vehicle comprising:
a chassis;
a body portion supported by a front end of the chassis, the body portion having a vehicle cabin in which an occupant rides inside the body portion;
a tilt mechanism provided on the chassis and configured to tilt the body portion with respect to the chassis;
a tank disposed on the body portion and configured to store gas;
a gas consuming unit supported by the chassis and configured to be supplied with the gas to consume the gas; and
a pipe configured to connect the tank and the gas consuming unit and configured such that the gas flows through the pipe,
wherein at least a part of the pipe is composed of a flexible pipe having a first end fixed to the body portion and a second end fixed to the chassis.

2. The freight vehicle according to claim 1, wherein the gas consuming unit includes a fuel cell configured to consume the gas to generate electric power.

3. The freight vehicle according to claim 1, wherein:
the flexible pipe has an upstream side portion on a side of the first end and a downstream side portion on a side of the second end; and
the flexible pipe is provided with a docking portion configured to detachably connect the upstream side portion and the downstream side portion.

4. The freight vehicle according to claim 1, wherein:
a part of the pipe is composed of a metal pipe connected to the tank and the flexible pipe and fixed to the body portion; and
a pressure regulating valve configured to reduce a pressure of the gas flowing out from the tank is provided between the metal pipe and the flexible pipe.

5. The freight vehicle according to claim 1, further comprising:
a container that is provided rearward of the body portion and in which freight is stored; and
a storage portion configured to store the tank,
wherein a height of the storage portion is equal to or lower than a height of a top surface of the container.

6. The freight vehicle according to claim 1, further comprising, when the tank is defined as a first tank, a second tank disposed between the body portion and a loading space that is provided rearward of the body portion and on which freight is loaded and configured to store the gas that is supplied to the gas consuming unit.
